(19) United States
(12) Patent Application Publication
(10) Pub. No.: US 2024/0166919 A1
(43) Pub. Date: May 23, 2024

(54) COMPONENT AND METHOD FOR PRODUCING THE SAME

(71) Applicants: HELLA GmbH & Co. KGaA, Lippstadt (DE); HELLA Saturnus Slovenija d.o.o., Ljubljana (SI)

(72) Inventors: Mohcyn BOUABDALLI, Zell im Wiesental (DE); Gasper DUCMAN, Ljubljana (SI); Peter SCHMITZ, Aidlingen (DE)

(73) Assignees: HELLA GmbH & Co. KGaA, Lippstadt (DE); HELLA Saturnus Slovenija d.o.o., Ljubljana (SI)

(21) Appl. No.: 18/516,970

(22) Filed: Nov. 22, 2023

(30) Foreign Application Priority Data
Nov. 22, 2022 (DE) 10 2022 130 810.3

(51) Int. Cl. C09J 7/22; B60R 13/04

(52) U.S. Cl. CPC C09J 7/22; B60R 13/04; C09J 2301/204

(57) ABSTRACT

A component that has a base designed as a planar component, wherein an elastic material is arranged on at least one section of a surface of a back side of the base. Also, a method for producing the component is provided.

This nonprovisional application claims priority under 35 U.S.C. § 119(a) to German Patent Application No. 10 2022 130 810.3, which was filed in Germany on Nov. 22, 2022, and which is herein incorporated by reference.

### BACKGROUND OF THE INVENTION

### Field of the Invention

The invention relates to a component and a method for producing the same.

### Description of the Background Art

Composite structures for a localized stiffening, as described in WO 2019/055710 A1, which corresponds to US 2020/0368997, which is herein incorporated by reference, are known from the prior art. A reinforcing device comprises a composite reinforcing patch. This reinforcing patch comprises a first layer with a first activatable material that is flexible and tacky in its green state prior to activation, and a second layer, either with a stabilizing material that is implemented as a mesh, a film, a chemical coating, a fibrous material, or a spherical material, or with a second activatable material that is located in planar contact with the activatable material of the first layer and along the entirety of a first surface of the activatable material of the first layer. The reinforcing patch optionally comprises a third layer that comprises a mesh, a film, a chemical coating, or a second activatable material, or a release paper, and that is located in planar contact with the activatable material and along the entire surface of the first layer or of the second layer, wherein, upon activation of the activatable material, the second layer, the optional third layer, or both layers provide(s) stability to the activatable material and minimize(s) shrinking of the activatable material.

A partition panel for vehicles and a method for producing the same are described in U.S. Pat. No. 10,214,245 B2, which is herein incorporated by reference. The partition panel comprises a panel part made of a composite material and a reinforcing part that is made of a composite material and extends from the center of the lower portion of the panel part upward to both ends of the panel part and is connected integrally to the panel part.

### SUMMARY OF THE INVENTION

It is therefore an object of the invention to provide a component that is improved over the prior art and a method for manufacturing the same that is improved over the prior art.

A component according to the invention has a base designed as a planar component, wherein an elastic, in particular viscoplastic, material is arranged on at least one section of a surface of a back side of the base, which material is joined to the base in a material-to-material manner, in particular. The elastic material is an adhesive, for example. In this case, provision is made, in particular, that a back side of the elastic material facing away from the back side of the base is nonbinding/remains free, which is to say is uncovered, which is to say is not in contact with another element of the component. The elastic material therefore is not intended, in particular, for joining the base to another element of the component. The elastic material consequently forms, in particular, an outer layer of a back side of the component.

The term “planar component” can be understood to mean, in particular, that the base is large-area and thin in design, in particular that a thickness of the base is substantially smaller, in particular is many time smaller, in particular is smaller by at least one order of magnitude or multiple orders of magnitude, than a length and/or a width and/or than a diameter of the base. The base consequently has the back side and a front side and, in particular, only a thin circumferential edge. The base, in particular its back side and/or its front side, can be straight or bent or curved in design.

The component is, for example, a component for a vehicle, in particular an attached part for a vehicle, in particular an exterior attached part for a vehicle, which is to say is for attachment to an exterior of the vehicle, for example forming a part of an outer skin of the vehicle. The component is, for example, a front component, in particular a front-end cover, of the vehicle, which is to say is intended for attachment to a front end of the vehicle. The component is, in particular, a large-area attached part, in particular a large-area attached trim part. The back side of the component, and thus the back side of the base, consequently faces toward the vehicle, and a front side of the component, and thus the front side of the base, faces away from the vehicle and, in particular, faces toward an outside environment of the vehicle. In particular, the front side of the base forms the front side of the component.

The base is made, for example, of plastic, in particular of a brittle plastic.

In the case of such components, in particular made of plastic, which tend toward brittle fracture behavior in a load situation, for example on account of their material selection and/or their manufacture, up to now the risk exists that they break or shatter, and consequently represent an injury hazard, in particular when they are located in a possible collision region of the vehicle. The fracture behavior of the component is improved substantially by the solution according to the invention. Advantageously, a load level up to fracture of the component is improved. Even after fracturing, the component advantageously does not fall apart, since fragments are held together by the elastic material. Consequently, the component is advantageously more ductile owing to the elastic material arranged on the base and/or a breaking of the component is prevented or at least a disintegration of the component after breaking is prevented or at least reduced owing to this elastic material. As a result, a compliance with legal requirements, for example regarding pedestrian protection, can be ensured, in particular.

In order to achieve the fracture behavior described, the elastic material is arranged on the at least one section of the surface of the back side of the base over the full surface or as straight or curved lines or stripes or as a grid pattern or mesh pattern, for example.

In order to achieve the fracture behavior described, the at least one section of the surface of the back side of the base on which the elastic material is arranged, or a totality of the sections of the surface of the back side of the base on which the elastic material is arranged, advantageously constitutes the largest part of the surface of the back side of the base, for example an entire free part of the surface of the back side of the base that is not covered by other elements. Such elements that cover other parts of the surface of the back side of the base are, for example, connecting elements for attaching the component to the vehicle and/or for connecting other vehicle elements to the component.

In a method according to the invention for producing the component, a material that is elastic, in particular viscoplastic, at least in a specified final state, is applied to at least one section of the surface of the back side of the base designed as a planar component, in particular made of plastic, in particular made of a brittle plastic. It is joined to the base in a material-to-material manner, in particular. The material is an adhesive, for example. The material, for example the adhesive, is applied in a liquid, viscous, or paste-like state, for example, and subsequently cures on its own, for example through a chemical reaction that takes place, or cures by means of additional measures, for example by means of light, infrared, and/or UV radiation, and/or through the action of heat, until the elastic final state is reached. In this case, provision is made, in particular, that no other element of the component is connected to the base by means of this material, which is to say a back side of the material that is elastic in the final state and that faces away from the back side of the base remains free, which is to say is uncovered, which is to say the back side of the material is not covered by another element of the component and consequently does not come into contact with any other element of the component. This material therefore is not intended, in particular, for joining the base to another element of the component. The material that is elastic in the final state consequently forms, in particular, an outer layer of the back side of the component.

The material is applied to the at least one section of the surface of the back side of the base over the full surface or as straight or curved lines or stripes or as a grid pattern or mesh pattern, for example.

As already described above, the at least one section of the surface of the back side of the base to which the material is applied, or a totality of the sections of the surface of the back side of the base to which the material is applied, advantageously constitutes the largest part of the surface of the back side of the base, for example an entire free part of the surface of the back side of the base that is not covered by other elements. Such elements that cover other parts of the surface of the back side of the base are, for example, connecting elements for attaching the component to the vehicle and/or for connecting other vehicle elements to the component.

The advantages already described above are attained by the method according to the invention.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWING

The present invention will become more fully understood from the detailed description given hereinbelow and the accompanying drawings which are given by way of illustration only, and thus, are not limitive of the present invention, and wherein the sole FIGURE shows a schematic representation of a component.

### DETAILED DESCRIPTION

The FIGURE shows, by way of example, a schematic representation of a component 1 in a top view of its back side.

In the depicted example, the component 1 is an exterior attached part for a vehicle, which is to say is intended for attachment to an exterior of the vehicle. The component 1 is, for example, a front component, in particular a front-end cover, of the vehicle, which is to say is intended for attachment to a front end of the vehicle. The component 1 is, in particular, a large-area attached part, in particular a large-area attached trim part.

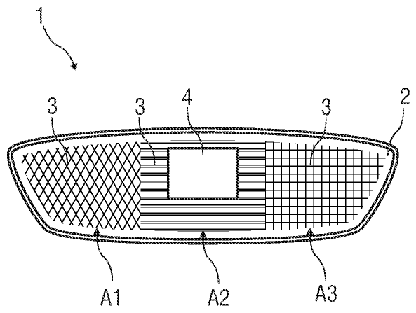

The component 1 has a base 2 designed as a planar component, which is made of plastic, in particular of a brittle plastic. Arranged on at least one section A1, A2, A3 of a surface of a back side of the base 2 is an elastic, in particular viscoplastic, material 3. In the depicted example, this elastic material 3 is an adhesive. It consequently is joined to the base 2 in a material-to-material manner. Provided by way of example in FIG. 1 in this case are three sections A1, A2, A3 of the surface of the back side of the base 2, on each of which the elastic material 3 is arranged. The elastic material 3 can, for example, be arranged on the at least one section A1, A2, A3 of the surface of the back side of the base 2 over the full surface or as straight or curved lines or stripes, for example curved in a zigzag shape, or as a grid pattern or mesh pattern. Some of these variants, or to be more precise, the straight lines or stripes and two different examples for the grid pattern or mesh pattern, are shown in the three sections A1, A2, A3 in FIG. 1 by way of example.

In the case of such components 1, when, as has been the case until now, they comprise only the base 2 of brittle plastic and tend toward brittle fracture behavior in a load situation, for example on account of their material selection and/or their manufacture, up to now the risk exists that they break or shatter, and consequently represent an injury hazard, in particular when they are located in a possible collision region of the vehicle. The fracture behavior of the component 1 is improved substantially by the solution described here. Advantageously, a load level up to fracture of the component 1 is improved. Even after fracturing, the component 1 advantageously does not fall apart, since fragments are held together by the elastic material 3. Consequently, the component 1 is advantageously more ductile owing to the elastic material 3 arranged on the base 2 and/or a breaking of the component 1 is prevented or at least a disintegration of the component 1 after breaking is prevented or at least reduced owing to this elastic material 3.

In order to achieve the fracture behavior described, the at least one section A1, A2, A3 of the surface of the back side of the base 2 on which the elastic material 3 is arranged or, in the example depicted here, a totality of the sections A1, A2, A3 of the surface of the back side of the base 2 on which the elastic material 3 is arranged, advantageously constitutes the largest part of the surface of the back side of the base 2, for example an entire free part of the surface of the back side of the base 2 that is not covered by other elements 4. Such elements 4 that cover other parts of the surface of the back side of the base 2 are, for example, connecting elements for attaching the component 1 to the vehicle and/or for connecting other vehicle elements to the component 1. Such an element 4 or a region on the component 1 for such an element 4 is shown by way of example, and schematically simplified, in FIG. 1.

To produce the component 1, therefore, a material 3 that is elastic, in particular viscoplastic, at least in a specified final state, is applied in a corresponding method to at least one section A1, A2, A3 or, as in the example shown, to multiple sections A1, A2, A3, of the surface of the back side of the base 2 designed as a planar component, in particular made of plastic, in particular of a brittle plastic. It is joined to the base 2 in a material-to-material manner, in particular. In the depicted example, the material 3 is an adhesive, as already mentioned above. The material 3, here the adhesive, is applied in a liquid, viscous, or paste-like state, for example, and subsequently cures on its own, for example through a chemical reaction that takes place, or cures by means of additional measures, for example by means of light, infrared, and/or UV radiation, and/or through the action of heat, until the elastic final state is reached.

As described above and shown by way of example in the different sections A1, A2, A3 in FIG. 1, the material 3 is applied to the at least one section A1, A2, A3 or the respective section A1, A2, A3 of the surface of the back side of the base 2 over the full surface or as straight or curved lines or stripes or as a grid pattern or mesh pattern, for example.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A component comprising:
a base designed as a planar component; and
an elastic material arranged on at least one section of a surface of a back side of the base.

2. The component according to claim 1, wherein the elastic material is joined in a material-to-material manner to the base.

3. The component according to claim 1, wherein the elastic material is arranged on the at least one section of the surface of the back side of the base over the full surface or as straight or curved lines or stripes or as a grid pattern or mesh pattern.

4. The component according to claim 1, wherein the elastic material is an adhesive.

5. The component according to claim 1, wherein the base is made of plastic.

6. The component according to claim 1, wherein the at least one section of the surface of the back side of the base on which the elastic material is arranged, or a totality of the sections of the surface of the back side of the base on which the elastic material is arranged, constitutes a largest part of the surface of the back side of the base.

7. The component according to claim 1, wherein the component is a design as an attached part for a vehicle.

8. A method for producing a component according to claim 1, the method comprising:
applying a material that is elastic, at least in a specified final state, to at least one section of the surface of the back side of the base designed as a planar component.

9. The method according to claim 8, wherein the material is applied to the at least one section of the surface of the back side of the base over the full surface or as straight or curved lines or stripes or as a grid pattern or mesh pattern.

10. The method according to claim 8, wherein an adhesive is applied as the material.
